(19) United States
(12) Patent Application Publication
(10) Pub. No.: US 2005/0173063 A1
(43) Pub. Date: Aug. 11, 2005

(54) Laminating method and laminating apparatus using the same

(75) Inventor: Masami Hiramoto, Kofu-shi (JP)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: CASIO MICRONICS CO., LTD.

(21) Appl. No.: 10/842,123

(22) Filed: May 10, 2004

(30) Foreign Application Priority Data
Feb. 10, 2004 (JP) 2004-033105

(51) Int. Cl. B32B 31/00

(52) U.S. Cl. 156/324; 156/361

(57) ABSTRACT

A laminating apparatus of this invention includes conveyor rollers which convey a carrier tape in the longitudinal direction, heating/pressing rollers which heat the carrier tape conveyed by the conveyor rollers on roller surfaces, and a convey path changing roller which adjusts contact areas in which the carrier tape comes into contact with the roller surfaces of the heating/pressing rollers.

### CROSS-REFERENCE TO RELATED APPLICATIONS

This application is based upon and claims the benefit of priority from prior Japanese Patent Application No. 2004-033105, filed Feb. 10, 2004, the entire contents of which are incorporated herein by reference.

### BACKGROUND OF THE INVENTION

1. Field of the Invention

The present invention relates to a laminating method of continuously heating and pressing a tape-like material such as a carrier tape to be heated and pressed while conveying the material in the longitudinal direction.

2. Description of the Related Art

Printed circuit boards such as carrier tapes for TAB, carrier tapes for chips on film (COFs), and flexible printed circuits (FPCs) are used in various applications such as monitors, liquid crystal drivers of portable apparatuses and the like, semiconductor ICs, and cables for connecting parts.

On a printed circuit board of this type, as shown in FIGS. 1 to 6, a wiring circuit is generally formed through steps of coating a conductor layer such as a copper foil with a photoresist (photosensitive agent), exposing wiring circuit patterns to light, and developing and etching the exposed patterns.

FIGS. 1 and 2 are sectional views taken along the widthwise direction of the board. FIG. 1 shows an example of a two-layered carrier tape. On an insulating layer 10 made of, e.g., polyimide, which serves as a base 14 of a printed circuit board, a conductor layer 12 made of, e.g., copper, which is formed into predetermined wiring circuit patterns is stacked. The surface of the conductor layer 12 is cleaned by degreasing, chemical polishing, or the like. The thickness of the copper conductor layer 12 is, e.g., about 8 to 12 μm, and the thickness of the polyimide insulating layer 10 is, e.g., about 25 to 50 μm.

FIG. 2 shows an example of a three-layered carrier tape in which an adhesive layer 16 for adhering an insulating layer 10 and conductor layer 12 is formed between them. In this structure, the thickness of the conductor layer 12 made of copper is, e.g., about 15 to 25 μm, the thickness of the insulating layer 10 made of polyimide is, e.g., about 75 μm, and the thickness of the adhesive layer 16 is, e.g., 12 μm.

The tape width and length of these two- and three-layered carrier tapes are about 35 to 350 mm and about 100 to 400 m, respectively. Sprocket holes 18 for reel-to-reel conveyance are formed at predetermined intervals on the two sides along the lengthwise direction of the tape.

Subsequently, as shown in FIG. 3, the surface of the conductor layer 12 is coated with a photoresist 19 about 4 μm thick except for the tape sides in which the sprocket holes 18 are formed. After that, as shown in FIG. 4, the photoresist 19 is irradiated with ultraviolet radiation 23 through a photomask 21 having predetermined wiring circuit patterns. Consequently, as shown in FIG. 4, the wiring circuit patterns are printed on the photoresist 19.

As shown in FIG. 5, the photoresist 19 is then developed by using a developer to leave photoresists 19(#a) in portions corresponding to the wiring circuit patterns. In addition, as shown in FIG. 6, etching is performed using an etchant 27 by a method such as dipping or spraying. The wiring circuit patterns formed in FIG. 5 are covered with the photoresists 19(#a) and not touched by the etchant. Therefore, the etching progresses only on portions where the holes are formed in the conductor layer 12. Finally, as shown in FIG. 6, the conductor layer 12 is removed from portions except for the wiring circuit patterns. After that, the remaining photoresists 19(#a) are peeled off. In this way, conductor layers 12(#a) formed into the predetermined wiring circuit patterns are obtained on the insulating layer 10.

As described previously, many copper foils used as the conductor layer 12 in the two-layered carrier tape have a thickness of about 8 to 12 μm. As the thickness of the copper foil increases, it becomes more difficult to obtain a fine wiring pitch. As the thickness of the copper foil decreases, fine wiring pitch patterns become easier to form. On the other hand, many copper foils used as the conductor layer 12 in the three-layered carrier tape have a thickness of 15 to 25 μm. Since no fine patterns can be formed, this three-layered carrier tape is unsuited to obtaining a fine wiring pitch. For this reason, two-layered carrier tapes are beginning to be extensively used for general purpose. In the three-layered carrier tape, the adhesive layer 16 is formed between the conductor layer 12 and insulting layer 10, and the conductor layer 12 and insulating layer 10 must be laminated.

This lamination is performed using a laminating apparatus as shown in FIG. 7. According to Jpn. Pat. Appln. KOKAI Publication No. 2002-210823, in this laminating apparatus as shown in FIG. 7, a vacuum laminator 1 as a first laminating device, second heat rolls 2 as a second laminating device and heating/pressing means including a pair of upper and lower rolls 67 and 68 opposing each other, and a take-up roller 3 for winding a base 14 on which upper and lower films 5 and 7 are laminated are arranged in this order from the upstream side to the downstream side in the winding direction of the base 14.

The vacuum laminator 1 includes a vacuum bath 4 as a pressure reduction bath, and the vacuum bath 4 contains an upper winding roll 6 on which the upper film 5 is wound, a lower winding roll 8 on which the lower film 7 is wound, and first heat rolls 9 as heating/pressing means including a pair of upper and lower rolls 65 and 66 opposing each other.

Upstream and downstream passing holes 61 and 62 for passing the base 14 are formed in the front and rear walls of the body of the vacuum bath 4. Also, upstream and downstream vacuum seal rolls 63 and 64 for holding the degree of vacuum in the vacuum bath 4 are arranged in the vicinities upstream and downstream of the upstream and downstream passing holes 61 and 62, respectively.

The upper and lower rolls 67 and 68 are heated by heaters (not shown). In this heated state, the upper and lower rolls 67 and 68 sandwich the base 14 on which the upper and lower films 5 and 7 are stacked, and heat and press the base 14 while feeding it.

This prior art reference describes that lamination is performed under conditions that the surface temperature of the second heat roll 2 is about 110° C., the pressure of the second heat roll 2 is 0.4 MPa, and the take-up speed of the take-up roller 3 is 0.5 m/min.

Unfortunately, this conventional laminating apparatus has the following problem.

That is, in the conventional laminating apparatus as shown in FIG. 7, the contact angles the upper and lower rolls 67 and 68 make with the base 14 are constant. Accordingly, to adjust the heating conditions such as the heating temperature and heating time, it is necessary to incorporate temperature controllers in the upper and lower rolls 67 and 68 and set these temperature controllers at a predetermined temperature, to adjust the heating time by adjusting the take-up speed of the take-up roller 3, or to combine these methods.

In these methods, however, it is not easy to finely adjust the heating conditions, and this makes it difficult to perform a lamination process with stable quality.

### BRIEF SUMMARY OF THE INVENTION

The present invention has been made in consideration of the above situation, and has as its object to provide a laminating method and laminating apparatus capable of easily and finely adjusting heating conditions even when continuously heating a tape-like material such as a carrier tape to be heated and pressed while conveying the material in the longitudinal direction.

To achieve the above object, the present invention uses the following means.

That is, a laminating method according to the first aspect of the present invention comprises a conveyance step of conveying a tape-like material to be heated and pressed in a longitudinal direction by conveyor means, a heating/pressing step of heating and pressing the material conveyed by the conveyor means on a roller surface of a heating/pressing roller, and a contact area adjusting step of adjusting a contact area in which the material comes into contact with the roller surface.

In the laminating method of the first aspect having the above means, therefore, even when a tape-like material such as a carrier tape to be heated and pressed is to be continuously heated as it is conveyed in the longitudinal direction, the heating conditions can be easily and finely adjusted by adjusting the contact area in which the material comes into contact with the roller surface, without adjusting the roller surface temperature or the take-up speed of the material.

According to the second aspect of the present invention, in the contact area adjusting step of the laminating method of the first aspect, the contact area is adjusted by changing a part of at least one of a convey path before heating and pressing along which the material is conveyed to the heating/pressing roller, and a convey path after heating and pressing along which the material heated and pressed by the heating/pressing roller is conveyed.

In the laminating method of the second aspect, therefore, the contact area between the material and roller surface can be adjusting by changing a part of the convey path before or after the heating/pressing roller. As a consequence, the heating conditions can be easily and finely adjusted without adjusting the roller surface temperature or the take-up speed of the material.

A laminating method according to the third aspect of the present invention comprises a conveyance step of conveying a tape-like material to be heated and pressed in a longitudinal direction by conveyor means, a heating/pressing step of heating and pressing the material conveyed by the conveyor means on a roller surface of a heating/pressing roller, a contact area adjusting step of adjusting a contact area in which the material comes into contact with the roller surface, and a time changing step of making a heating time during which the material is heated by the heating/pressing roller different from a pressing time during which the material is pressed by the heating/pressing roller.

In the laminating method of the third aspect, therefore, it is possible not only to perform simple fine adjustment, but also to make the heating time and pressing time different from each other, e.g., make the heating time longer.

A laminating method according to the fourth aspect of the present invention comprises a conveyance step of conveying a tape-like material to be heated and pressed in a longitudinal direction by conveyor means, a heating/pressing step of heating and pressing the material conveyed by the conveyor means on a roller surface of each of a plurality of heating/pressing rollers, and a time changing step of making a heating time during which the material is heated by each heating/pressing roller different from a pressing time during which the material is pressed by the heating/pressing roller.

In the laminating method of the fourth aspect, therefore, it is possible not only to perform simple fine adjustment, but also to make the heating time and pressing time different from each other, e.g., make the heating time longer. In addition, since a plurality of heating/pressing rollers are used, a material to be heated and pressed can be continuously pressed a plurality of times by performing the processing once.

A laminating method according to the fifth aspect of the present invention comprises a conveyance step of conveying a tape-like material to be heated and pressed in a longitudinal direction by conveyor means, and a contact area adjusting step of changing a part of a convey path of the material conveyed by the conveyor means such that the material is introduced, via the changed convey path, between a pair of roller surfaces of a pair of heating/pressing rollers which are so arranged that the roller surfaces oppose each other, and which heat the material introduced between the pair of roller surfaces from upper and lower surfaces of the material by the roller surfaces, thereby adjusting contact areas in which the upper and lower surfaces of the material come into contact with the roller surfaces.

In the laminating method of the fifth aspect, therefore, the contact area between the material and roller surface can be adjusted by changing a part of the convey path before the heating/pressing roller. As a consequence, the heating conditions can be easily and finely adjusted without adjusting the roller surface temperature or the take-up speed of the material.

A laminating method according to the sixth aspect of the present invention comprises a conveyance step of conveying a tape-like material to be heated and pressed in a longitudinal direction by conveyor means, and a contact area adjusting step of changing a part of a convey path of the material conveyed by the conveyor means, and conveyed from between a pair of roller surfaces of a pair of heating/pressing rollers which are so arranged that the roller surfaces oppose each other, and which heat and press the material introduced between the pair of roller surfaces from upper and lower surfaces of the material by the roller surfaces, thereby adjusting contact areas in which the upper and lower surfaces of the material come into contact with the roller surfaces.

In the laminating method of the sixth aspect, therefore, the contact area between the material and roller surface can be adjusted by changing a part of the convey path after the heating/pressing roller. As a consequence, the heating conditions can be easily and finely adjusted without adjusting the roller surface temperature or the take-up speed of the material.

A laminating method according to the seventh aspect of the present invention comprises a conveyance step of conveying a tape-like material to be heated and pressed in a longitudinal direction by conveyor means, a first contact area adjusting step of changing a part of a convey path of the material conveyed by the conveyor means such that the material is introduced, via the changed convey path, between a pair of roller surfaces of a pair of heating/pressing rollers which are so arranged that the roller surfaces oppose each other, and which heat the material introduced between the pair of roller surfaces from upper and lower surfaces of the material by the roller surfaces, thereby adjusting contact areas in which the upper and lower surfaces of the material come into contact with the roller surfaces, and a second contact area adjusting step of changing a part of a convey path of the material conveyed by the conveyor means and discharged from between the pair of roller surfaces, thereby adjusting contact areas in which the upper and lower surfaces of the material come into contact with the roller surfaces.

In the laminating method of the seventh aspect, therefore, the contact area between the material and roller surface can be adjusted by changing a part of each of the convey paths before and after the heating/pressing roller. As a consequence, the heating conditions can be easily and finely adjusted without adjusting the roller surface temperature or the take-up speed of the material.

The eighth aspect of the present invention comprises, in the laminating method of any one of the first to seventh aspects, a stacked material information storage step of prestoring, in a stacked material information storage database, arrangement information and area information of stacked materials stacked on the material to be heated and pressed, a pressing pattern calculation step of calculating, on the basis of the information stored in the stacked material information storage database, a pressing pattern by which a predetermined pressure is applied to the stacked materials by the heating/pressing roller in the longitudinal direction of the material to be heated and pressed, and a pressing step of causing the heating/pressing roller to apply a pressure to the material to be heated and pressed, in accordance with the pressing pattern calculated in the pressing pattern calculation step, thereby heating the stacked materials as they are pressed by the predetermined pressure in the longitudinal direction by the heating/pressing roller.

Accordingly, in the laminating method of the eighth aspect having the above means, even when a material to be heated and pressed on which stacked materials are arranged is to be heated, all the stacked materials can be pressed with a predetermined pressure, and the heating conditions can be easily and finely-adjusted.

A laminating apparatus according to the ninth aspect of the present invention comprises conveyor means for conveying a tape-like material to be heated and pressed in a longitudinal direction, a heating/pressing roller which heats and presses the material conveyed by the conveyor means on a roller surface, and contact area adjusting means for adjusting a contact area in which the material comes into contact with the roller surface.

Accordingly, in the laminating apparatus of the ninth aspect having the above means, even when a tape-like material such as a carrier tape to be heated and pressed is to be continuously heated as it is conveyed in the longitudinal direction, the heating conditions can be easily and finely adjusted by adjusting the contact area in which the material comes into contact with the roller surface, without adjusting the roller surface temperature or the take-up speed of the material.

According to the 10th aspect of the present invention, in the laminating apparatus of the ninth aspect, the contact area adjusting means adjusts the contact area by changing a part of at least one of a convey path before heating and pressing along which the material is conveyed to the heating/pressing roller, and a convey path after heating and pressing along which the material heated and pressed by the heating/pressing roller is conveyed.

In the laminating apparatus of the 10th aspect, therefore, the contact area between the material and roller surface can be adjusted by changing a part of the convey path before or after the heating/pressing roller. As a consequence, the heating conditions can be easily and finely adjusted without adjusting the roller surface temperature or the take-up speed of the material.

A laminating apparatus according to the 11th aspect of the present invention comprises conveyor means for conveying a tape-like material to be heated and pressed in a longitudinal direction, a pair of heating/pressing rollers which are so arranged that a pair of roller surfaces thereof oppose each other, and which heat and press the material introduced between the pair of roller surfaces from upper and lower surfaces of the material by the roller surfaces, and contact area adjusting means for changing a part of a convey path of the material conveyed by the conveyor means such that the material is introduced between the pair or roller surfaces via the changed convey path, thereby adjusting contact areas in which the upper and lower surfaces of the material come into contact with the roller surfaces.

In the laminating apparatus of the 11th aspect, therefore, the contact area between the material and roller surface can be adjusted by changing a part of the convey path before the heating/pressing roller. As a consequence, the heating conditions can be easily and finely adjusted without adjusting the roller surface temperature or the take-up speed of the material.

A laminating apparatus according to the 12th aspect of the present invention comprises conveyor means for conveying a tape-like material to be heated and pressed in a longitudinal direction, a pair of heating/pressing rollers which are so arranged that a pair of roller surfaces thereof oppose each other, and which heat and press the material introduced between the pair of roller surfaces from upper and lower surfaces of the material by the roller surfaces, and contact area adjusting means for changing a part of a convey path of the material conveyed by the conveyor means and conveyed from between the pair of roller surfaces, thereby adjusting contact areas in which the upper and lower surfaces of the material come into contact with the roller surfaces.

In the laminating apparatus of the 12th aspect, therefore, the contact area between the material and roller surface can be adjusted by changing a part of the convey path after the heating/pressing roller. As a consequence, the heating conditions can be easily and finely adjusted without adjusting the roller surface temperature or the take-up speed of the material.

A laminating apparatus according to the 13th aspect of the present invention comprises conveyor means for conveying a tape-like material to be heated and pressed in a longitudinal direction, a pair of heating/pressing rollers which are so arranged that a pair of roller surfaces thereof oppose each other, and which heat and press the material introduced between the pair of roller surfaces from upper and lower surfaces of the material by the roller surfaces, first contact area adjusting means for changing a part of a convey path of the material conveyed by the conveyor means such that the material is introduced between the pair of opposing roller surfaces via the changed convey path, thereby adjusting contact areas in which the upper and lower surfaces of the material come into contact with the roller surfaces, and second contact area adjusting means for changing a part of a convey path of the material conveyed by the conveyor means and discharged from between the pair of roller surfaces, thereby adjusting contact areas in which the upper and lower surfaces of the material come into contact with the roller surfaces.

In the laminating apparatus of the 13th aspect, therefore, the contact area between the material and roller surface can be adjusted by changing a part of each of the convey paths before and after the heating/pressing roller. As a consequence, the heating conditions can be easily and finely adjusted without adjusting the roller surface temperature or the take-up speed of the material.

According to the 14th aspect of the present invention, in the laminating apparatus of any one of the 11th to 13th aspects, two heating/pressing rollers opposing each other and different in diameter are used instead of the pair of heating/pressing rollers.

In the laminating apparatus of the 14th aspect, therefore, the heating conditions can be easily and finely adjusted.

According to the 15th aspect of the present invention, in the laminating apparatus of the 14th aspect, a portion of an outer circumference of a small-diameter heating/pressing roller is positioned, on a circumference of a large-diameter heating/pressing roller, between first and second contact points at which the material comes into contact with the large-diameter heating/pressing roller.

In the laminating apparatus of the 15th aspect, therefore, the heating conditions can be easily and finely adjusted.

According to the 16th aspect, in the laminating apparatus of any one of the 11th to 15th aspects, at least two heating/pressing rollers different in diameter are used instead of the pair of heating/pressing rollers, and a part of an outer circumference of at least one heating/pressing roller having a diameter smaller than that of a large-diameter heating/pressing roller is positioned, on a circumference of the large-diameter heating/pressing roller, between first and second contact points at which the material comes into contact with the large-diameter heating/pressing roller.

In the laminating apparatus of the 16th aspect, therefore, the heating conditions can be easily and finely adjusted.

The 17th aspect of the present invention comprises, in the laminating apparatus of any one of the ninth to 16th aspects, stacked material information storage means for prestoring arrangement information and area information of stacked materials stacked on the material to be heated and pressed, pressing pattern calculating means for calculating, on the basis of the information stored in the stacked material information storage, a pressing pattern by which a predetermined pressure is applied to the stacked materials by the heating/pressing roller in the longitudinal direction of the material to be heated and pressed, and pressing means for causing the heating/pressing roller to apply a pressure to the material to be heated and pressed, in accordance with the pressing pattern calculated by the pressing pattern calculating means, thereby heating the stacked materials as they are pressed by the predetermined pressure in the longitudinal direction by the heating/pressing roller.

Accordingly, in the laminating apparatus of the 17th aspect having the above means, even when a material to be heated and pressed on which stacked materials are arranged is to be heated, all the stacked materials can be heated with a predetermined pressure, and the heating conditions can be easily and finely adjusted.

A laminating apparatus according to the 18th aspect of the present invention comprises conveyor means for conveying a tape-like material to be heated and pressed in a longitudinal direction, a heating/pressing roller which heats and presses the material conveyed by the conveyor means on a roller surface, contact area adjusting means for adjusting a contact area in which the material comes into contact with the roller surface, and time changing means for making a heating time during which the material is heated by the heating/pressing roller different from a pressing time during which the material is pressed by the heating/pressing roller.

In the laminating apparatus of the 18th aspect, therefore, it is possible not only to perform simple fine adjustment, but also to make the heating time and pressing time-different from each other, e.g., make the heating time longer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention and, together with the general description given above and the detailed description of the preferred embodiments given below, serve to explain the principles of the invention.

FIG. 1 is a vertical sectional view of a two-layered carrier tape taken along the widthwise direction of a board;

FIG. 2 is a vertical sectional view of a three-layered carrier tape taken along the widthwise direction of the board;

FIG. 3 is a vertical sectional view of the board when it is coated with a photoresist;

FIG. 4 is a vertical sectional view of the board during exposure;

FIG. 5 is a vertical sectional view of the board during development;

FIG. 6 is a vertical sectional view of the board during etching;

FIG. 7 is a system configuration view of the conventional laminating apparatus;

FIG. 8 is a system configuration view showing an example of a laminating apparatus using a laminating method according to the first embodiment;

FIG. 9 is a vertical sectional view showing an example of a carrier tape on which a conductor layer made of, e.g., copper is stacked on the upper surface of an insulating layer made of, e.g., polyimide;

FIG. 10 is a system configuration view for explaining the function of a convey path changing roller in the laminating apparatus using the laminating method according to the first embodiment;

FIG. 11 is a system configuration view showing an example of a laminating apparatus using a laminating method according to the second embodiment;

FIG. 12 is a system configuration view showing an example of a laminating apparatus using a laminating method according to the third embodiment;

FIG. 13 is a system configuration view showing an example of a laminating apparatus using a laminating method according to the fourth embodiment;

FIG. 14 is a system configuration view showing an example of a laminating apparatus using a laminating method according to the fifth embodiment;

FIG. 15 is a system configuration view showing an example of a laminating apparatus using a laminating method according to the sixth embodiment;

FIG. 16 is a system configuration view showing an example of a laminating apparatus using a laminating method according to the seventh embodiment;

FIG. 17 is a plan view showing an example of a carrier tape on which resists are arranged;

FIG. 18 is a vertical sectional view showing an example of the carrier tape on which resists are arranged; and

FIG. 19 is a graph showing an example of a pressing pattern.

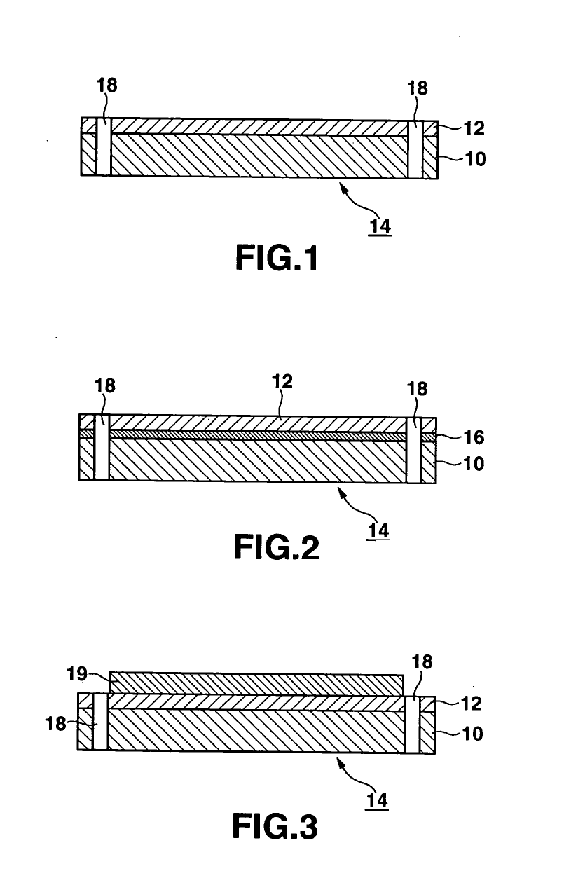

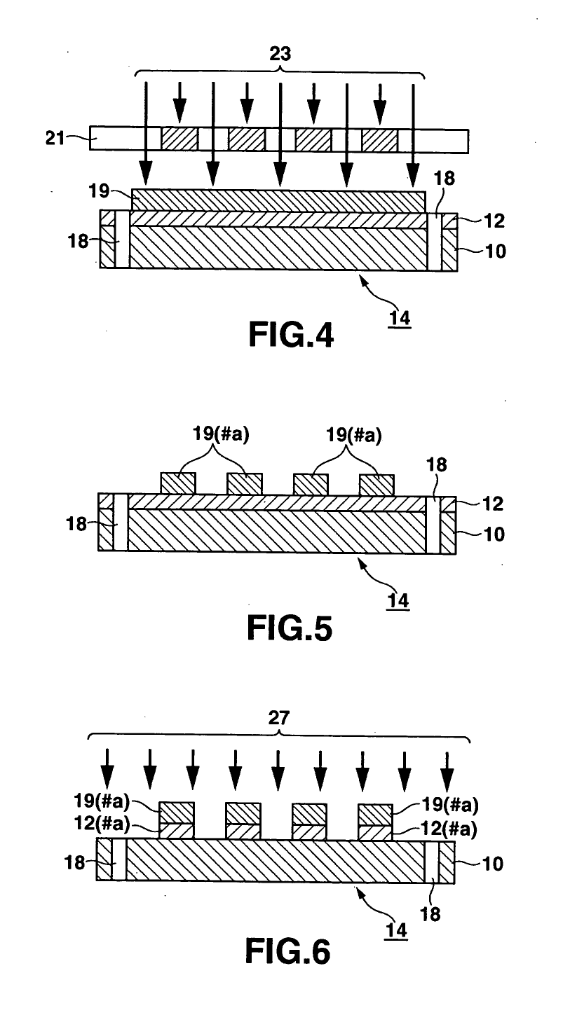

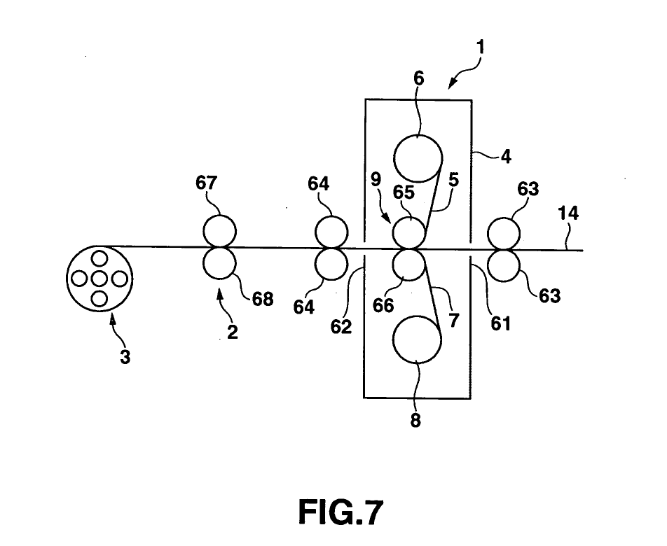

### DETAILED DESCRIPTION OF THE INVENTION

The best mode for carrying out the present invention will be described below with reference to the accompanying drawing.

### First Embodiment

The first embodiment of the present invention will be explained below.

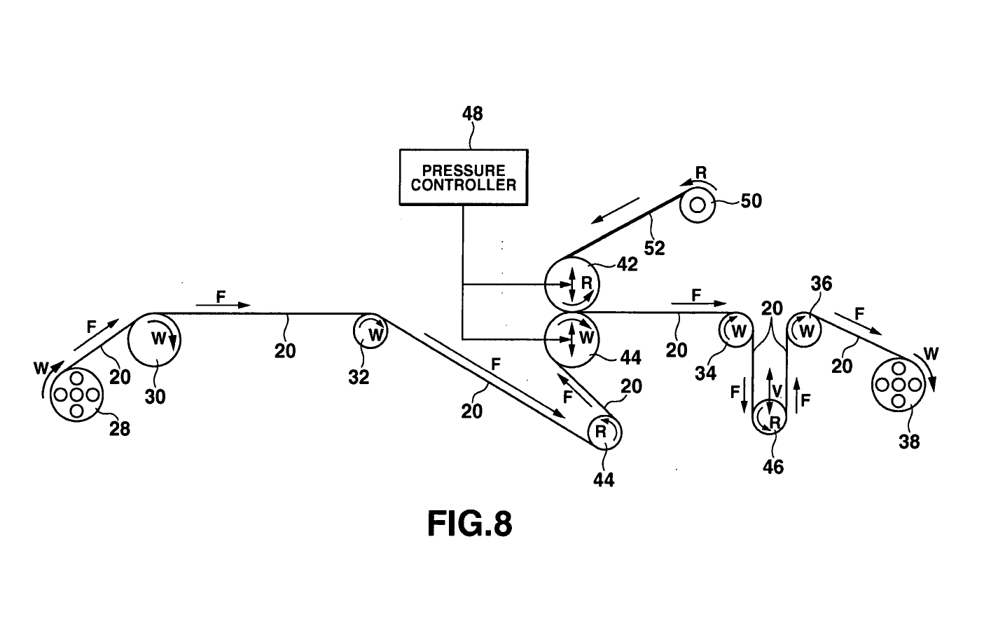

FIG. 8 is a system configuration view showing an example of a laminating apparatus using a laminating method according to the first embodiment.

That is, the laminating apparatus according to this embodiment continuously heats a tape-like material such as a carrier tape to be heated and pressed while conveying-the-material in the longitudinal direction which is a conveyance direction F in FIG. 8.

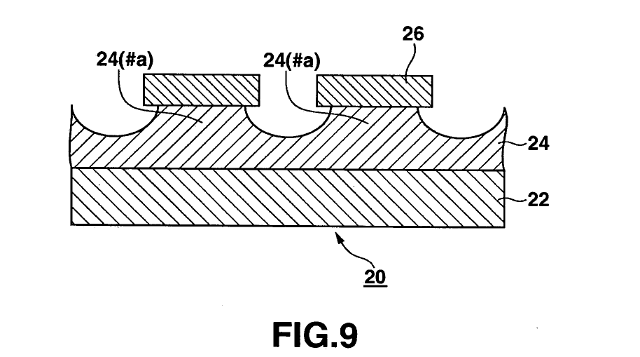

This embodiment will be explained below by taking a carrier tape 20 as an example of the material to be heated and pressed. As shown in a vertical sectional view of FIG. 9, the carrier tape 20 to be heated by the laminating apparatus according to this embodiment is obtained by stacking a conductor layer 24 made of, e.g., copper on the upper surface of an insulating layer 22 made of, e.g., polyimide. On the conductor layer 24, resists 26 are arranged in portions corresponding to predetermined wiring patterns. Portions where the resists 26 are not formed are depressed by half etching performed by a method such as immersion wet etching or shower etching. By this half etching, conductor layers 24(#a) are formed below the photoresists 26 of wiring circuit patterns so as to have a top width smaller than the width of each photoresist 26.

In the laminating apparatus according to this embodiment, a conveyor mechanism is made up of a supply roller 28, conveyor rollers 30, 32, 34, and 36, and take-up roller 38. The carrier tape 20 as a material to be heated and pressed is wound into the form of a roll on the supply roller 28. By rotating the supply roller 28 around its central axis in a clockwise direction W shown in FIG. 8 by receiving a driving force from a rotating mechanism (not shown), the wound carrier tape 20 is unwound to the conveyor roller 30. The conveyor roller 30 similarly rotates in the clockwise direction W to convey the carrier tape 20 unwound from the supply roller 28 in the conveyance direction F to the conveyor roller 32. The conveyor roller 32 also similarly rotates in the clockwise direction W to convey the carrier tape 20 conveyed from the conveyor roller 30 to the conveyor roller 34 via a convey path changing roller 40 (to be described later) and a pair of heating/pressing rollers 42 and 44 (to be described later). The conveyor roller 34 rotates in the same clockwise direction W as above to convey the carrier tape 20 to the conveyor roller 36 via a dancer roller 46 (to be described later). The conveyor roller 36 rotates in the same clockwise direction W as above to convey the carrier tape 20 to the take-up roller 38. The take-up roller 38 also rotates in the same clockwise direction W as above to wind the carrier tape 20 conveyed from the conveyor roller 36.

The convey path changing roller 40, the pair of heating/pressing rollers 42 and 44, and the dancer roller 46 are arranged midway along the convey path in which the carrier tape 20 is conveyed by the conveyor mechanism described above.

The pair of heating/pressing rollers 42 and 44 are so arranged that their roller surfaces oppose each other. The carrier tape-20 introduced between the pair of roller surfaces are heated from the upper and lower surfaces by these roller surfaces. The heating/pressing rollers 42 and 44 rotate in a counterclockwise direction R and the clockwise direction W, respectively, by receiving driving forces from rotating mechanisms (not shown), thereby feeding the introduced carrier tape 20 to the conveyor roller 34.

The laminating apparatus according to this embodiment further includes a pressure controller 48. The pressure controller 48 outputs, to the pair of heating/pressing rollers 42 and 44, an instruction for controlling the pressure which is applied from the pair of roller surfaces of the heating/pressing rollers 42 and 44 to the carrier tape 20 introduced between them. On the basis of this control instruction, therefore, the pair of heating/pressing rollers 42 and 44 apply a pressure to the carrier tape 20 introduced between the two roller surfaces.

In this manner, the carrier tape 20 introduced between the roller surfaces of the pair of heating/pressing rollers 42 and 44 is continuously heated and pressed by the heating/pressing rollers 42 and 44, and conveyed to the conveyor roller 34.

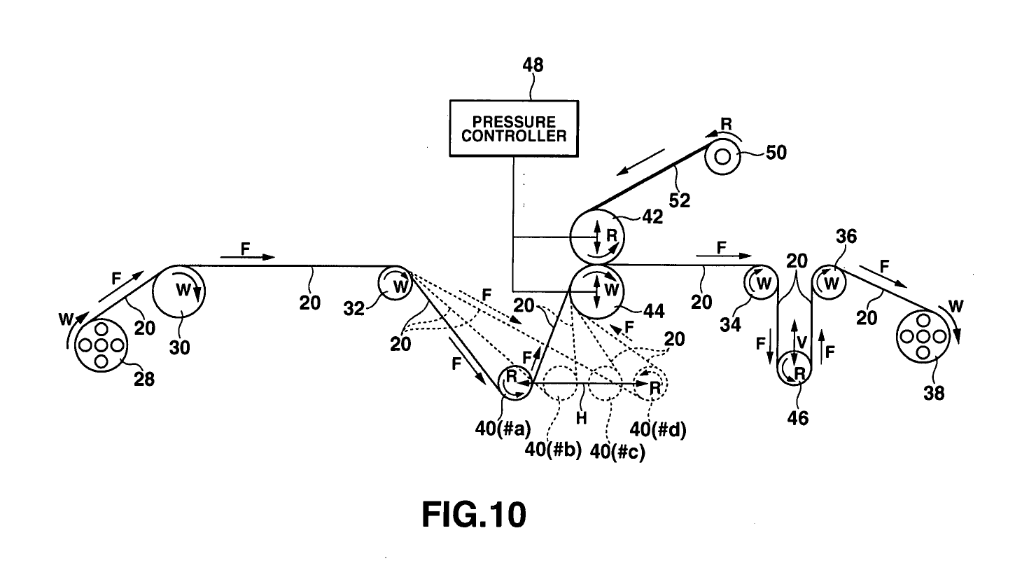

As shown in FIG. 10, the convey path changing roller 40 can move in a horizontal direction H by an air-cylinder or the like (not shown). The convey path-changing roller 40 changes a part of the convey path from the conveyor roller 32 to the heating/pressing rollers 42 and 44, thereby adjusting the contact area in which the carrier tape 20 comes into contact with the roller surface of the heating/pressing roller 44. That is, as indicated by a convey path changing roller 40(#a) shown in FIG. 10, as the position of the convey path changing roller 40 moves to the upstream side in the conveyance direction F, the lower surface of the carrier tape 20 is brought into contact more shallowly with the roller surface of the heating/pressing roller 44, and then introduced between the pair of roller surfaces. This decreases the area of contact with the roller surface, and hence decreases the heating amount from the lower surface of the carrier tape 20. On the other hand, as indicated by convey path changing rollers 40(#b), 40(#c), and 40(#d), as the position of the convey path changing roller 40 moves to the downstream side in the conveyance direction F, the lower surface of the carrier tape 20 is brought into contact more deeply with the roller surface of the heating/pressing roller 44, and then introduced between the pair of roller surfaces. This increases the area of contact with the roller surface, and hence increases the heating amount from the lower surface of the carrier tape 20.

The dancer roller 46 can move in a vertical direction V shown in FIG. 8 by an air cylinder or the like (not shown). By freely changing the position of the dancer roller 46 in the vertical direction V, the carrier tape 20 is given tension and conveyed to the take-up roller 38 without being slack during the course of conveyance.

The laminating apparatus according to this embodiment further includes a resist supply roller 50. This makes it possible to heat and press the upper surface of the carrier tape 20, which is covered with a resist 52 such as a copper foil or release sheet.

That is, the resist 52 such as a copper foil or release sheet is wound on the resist supply roller 50. The resist supply roller 50 rotates around its central axis in the counterclockwise direction R to unwind the wound resist 52 to the heating/pressing roller 42. Consequently, the surface of the carrier tape 20, which is covered with the resist 52 is heated and pressed by the heating/pressing rollers 42 and 44. After that, the carrier tape 20 having the upper surface covered with the resist 52 is conveyed to the conveyor roller 34, and finally wound by the take-up roller 38.

The function of the laminating apparatus according to this embodiment having the above arrangement will be described below.

That is, in the laminating apparatus according to this embodiment, the carrier tape 20 is unwound from the supply roller 28, and conveyed to the convey path changing roller 40 via the conveyor rollers 30 and 32.

The convey path changing roller 40 can freely change its position in the horizontal direction H, thereby changing a part of the convey path from the conveyor roller 32 to the heating/pressing rollers 42 and 44. Since the carrier tape 20 is supplied to the heating/pressing rollers 42 and 44 after the convey path is thus changed, the contact area in which the lower surface of the carrier tape 20 comes into contact with the roller surface of the heating/pressing roller 44 is changed. In this case, as the position of the convey path changing roller 40 moves to the upstream side in the conveyance direction F, the lower surface of the carrier tape 20 is brought into contact more shallowly with the roller surface of the heating/pressing roller 44, and then introduced between the pair of roller surfaces. This decreases the area of contact with the roller surface, i.e., shortens the heating time, and hence decreases the heating amount from the lower surface of the carrier tape 20. On the other hand, as the position of the convey path changing roller 40 moves to the downstream side in the conveyance direction F, the lower surface of the carrier tape 20 is brought into contact more deeply with the roller surface of the heating/pressing roller 44, and then introduced between the pair of roller surfaces. This increases the area of contact with the roller surface, i.e., prolongs the heating time, and hence increases the heating amount from the lower surface of the carrier tape 20.

In accordance with the control instruction from the pressure controller 48, the pressure applied to the carrier tape 20 introduced between the two roller surfaces of the heating/pressing rollers 42 and 44 is controlled. Since this pressure is applied on the contact surface between the two rollers, the pressing time is always constant unlike the heating time. In this way, the carrier tape 20 is heated with the adjusted heating amount and pressed with the controlled pressure by the heating/pressing rollers 42 and 44, and continuously conveyed to the conveyor roller 34.

To heat and press the upper surface of the carrier tape 20, which is covered with the resist 52 such as a copper foil or release sheet, the resist supply roller 50 is rotated in the counterclockwise direction R. As a consequence, the resist 52 is unwound to the heating/pressing roller 42, and the upper surface of the carrier tape 20, which is covered with the resist 52 is heated and pressed by the heating/pressing rollers 42 and 44.

The carrier tape 20 thus continuously heated and pressed is fed to the conveyor roller 34 by the heating/pressing rollers 42 and 44, and wound by the take-up roller 38 via the conveyor roller 36.

The dancer roller 46 is inserted between the conveyor rollers 34 and 36. The dancer roller 46 moves in the vertical direction V to give tension to the carrier tape 20. Therefore, in the convey path from the supply roller 28 to the take-up roller 38 as described above, the carrier tape 20 is conveyed without producing any slackness during the course of conveyance.

In the laminating apparatus according to this embodiment as described above, the heating amount of the carrier tape 20 can be reduced by moving the position in the horizontal direction H of the convey path changing roller 40 to the upstream side in the conveyance direction F. On the other hand, the heating amount of the carrier tape 20 can be increased by moving this position to the downstream side in the conveyance direction F.

That is, even when a tape-like material to be heated and pressed, such as the carrier tape 20, is to be continuously heated as it is conveyed in the longitudinal direction, the heating conditions can be easily and finely adjusted by adjusting the contact area in which the material comes into contact with the roller surface, without changing the roller surface temperature or the take-up speed of the material.

### Second Embodiment

The second embodiment of the present invention will be described below.

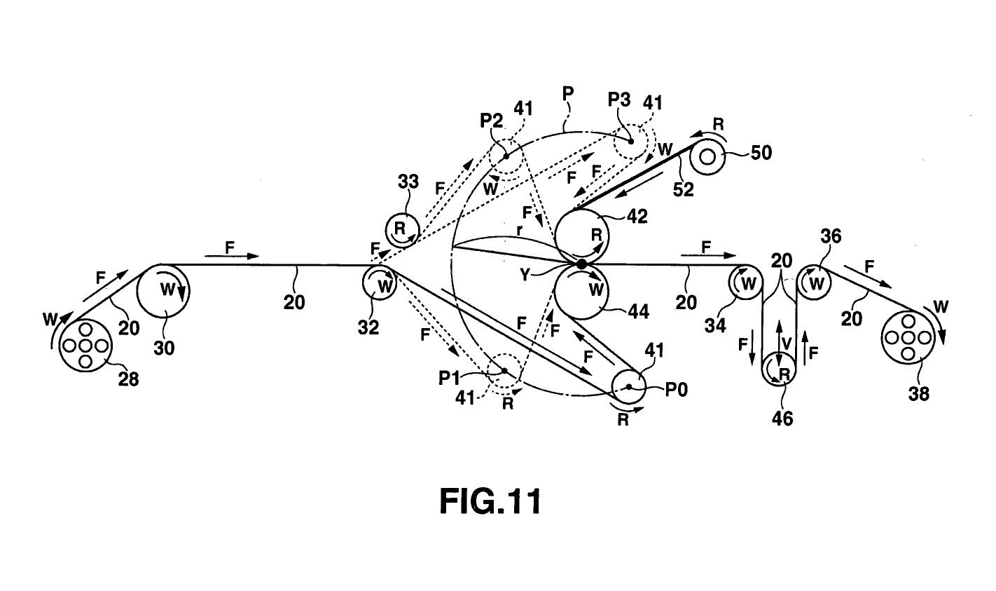

FIG. 11 is a system configuration view showing an example of a laminating apparatus using a laminating method according to the second embodiment.

That is, the laminating apparatus according to this embodiment is a modification of the laminating apparatus according to the first embodiment. The only differences are that a conveyor roller 33 is added and a convey path changing roller 41 is used instead of the convey path changing roller 40. Therefore, only the differences will be described below, and a repetitive explanation will be avoided. Note that a pressure controller 48 is not shown in FIG. 11.

The convey path changing roller 41 can move along a circumference P of a circle having a point Y as the center and a radius r. The point Y is a contact point of a pair of heating/pressing rollers 42 and 44. The radius r is a distance by which the convey path changing roller 41 does not collide against a conveyor roller 32, the conveyor roller 33, and the pair of heating/pressing rollers 42 and 44, even when moving along the circumference P.

When the convey path changing roller 41 is on the side of the heating/pressing roller 44 as indicated by P0 or P1, a carrier tape 20 which is conveyed from the conveyor roller 32 to the lower side of the convey path changing roller 41 is fed in a counterclockwise direction R. Accordingly, the lower surface of the carrier tape 20 is brought into contact with the roller surface of the heating/pressing roller 44, and then the carrier tape 20 is introduced between the pair of heating/pressing rollers 42 and 44. As in the first embodiment, as the position of the convey path changing roller 41 moves to the upstream side (e.g., P1) in a conveyance direction F, the lower surface of the carrier tape 20 is brought into contact more shallowly with the roller surface of the heating/pressing roller 44, and then introduced between the pair of roller surfaces. This decreases the area of contact with the roller surface, and hence decreases the heating amount from the lower surface of the carrier tape 20. On the other hand, as the position of the convey path changing roller 41 moves to the downstream side (e.g., P0) in the conveyance direction F, the lower surface of the carrier tape 20 is brought into contact more deeply with the roller surface of the heating/pressing roller 44, and then introduced between the pair of roller surfaces. This increases the area of contact with the roller surface, and hence increases the heating amount from the lower surface of the carrier tape 20.

When the convey path changing roller 41 is on the side of the heating/pressing roller 42 as indicated by P2 or P3, the carrier tape 20 which is conveyed from the conveyor roller 33 to the upper side of the convey path changing roller 41 is fed in a clockwise direction W. Accordingly, the upper surface of the carrier tape 20 is brought into contact with the roller surface of the heating/pressing roller 42, and then the carrier tape 20 is introduced between the pair of rollers. As the position of the convey path changing roller 41 moves to the upstream (e.g., P2) in the conveyance direction F, the upper surface of the carrier tape 20 is brought into contact more shallowly with the roller surface of the heating/pressing roller 42, and then introduced between the pair of roller surfaces. This decreases the area of contact with the roller surface, and hence decreases the heating amount from the upper surface of the carrier tape 20. On the other hand, as the position of the convey path changing roller 41 moves to the downstream side (e.g., P3) in the conveyance direction F, the upper surface of the carrier tape 20 is brought into contact more deeply with the roller surface of the heating/pressing roller 42, and then introduced between the pair of roller surfaces. This increases the area of contact with the roller surface, and hence increases the heating amount from the upper surface of the carrier tape 20.

The conveyor roller 33 rotates in the counter-clockwise direction R when the convey path changing roller 41 is on the side of the heating/pressing roller 42 as indicated by P2 or P3. As a consequence, the carrier tape 20 conveyed from the conveyor roller 32 is conveyed to the convey path changing roller 41.

In the laminating apparatus having the arrangement as described above, when the position of the convey path changing roller 41 is on the side of the heating/pressing roller 44 as indicated by P0 or P1, the carrier tape 20 is conveyed from the conveyor roller 32 to the lower side. When the convey path changing roller 41 is on the side of the heating/pressing roller 42 as indicated by P2 or P3, the carrier tape 20 is conveyed from the conveyor roller 33 to the upstream side. Therefore, to change the position of the convey path changing roller 41 from the side of the heating/pressing roller 42 to the side of the heating/pressing roller 44 or vice versa, the conveyance of the carrier tape 20 is temporarily stopped, and the positions of winding of the carrier tape 20 on the convey path changing roller 41 are manually switched. That is, to change the position of the convey path changing roller 41 from the side of the heating/pressing roller 42 to the side of the heating/pressing roller 44, the winding position of the carrier tape 20 conveyed to the upper side of the convey path changing roller 41 is so changed that the carrier tape 20 is conveyed to the lower side of the convey path changing roller 41. To change the position of the convey path changing roller 41 from the side of the heating/pressing roller 44 to the side of the heating/pressing roller 42, the winding position of the carrier tape 20 conveyed to the lower side of the convey path changing roller 41 is so changed that the carrier tape 20 is conveyed to the upper side of the convey path changing roller 41.

In the laminating apparatus according to this embodiment having the above arrangement, the convey path changing roller 41 can freely change its position along the circumference P of the circle having the point Y as the center and the radius r. The carrier tape 20 is fed to the heating/pressing rollers 42 and 44 after a part of the convey path of the carrier tape 20 from the conveyor roller 32 of 33 to the heating/pressing rollers 42 and 44 is changed by the convey path changing roller 41. Consequently, the contact area in which the lower surface of the carrier tape 20 comes into contact with the roller surface of the heating/pressing roller 44 is adjusted.

When the convey path changing roller 41 is on the side of the heating/pressing roller 44 as indicated by P0 or P1, the carrier tape 20 which is conveyed from the conveyor roller 32 to the convey path changing roller 41 is introduced between the pair of heating/pressing rollers 42 and 44 after the lower surface of the carrier tape 20 is brought into contact with the roller surface of the heating/pressing roller 44. As in the first embodiment, as the position of the convey path changing roller 41 moves to the upstream side (e.g., P1) in the conveyance direction F, the area of contact with the roller surface decreases, and this decreases the heating amount from the lower surface of the carrier tape 20. On the other hand, as the position of the convey path changing roller 41 moves to the downstream side (e.g., P0) in the conveyance direction F, the area of contact with the roller surface increases, and this increases the heating amount from the lower surface of the carrier tape 20.

When the convey path changing roller 41 is on the side of the heating/pressing roller 42 as indicated by P2 or P3, the carrier tape 20 which is conveyed from the conveyor roller 33 is introduced between the pair or rollers after the upper surface of the carrier tape 20 is brought into contact with the roller surface of the heating/pressing roller 42. As the position of the convey path changing roller 41 moves to the upstream side (e.g., P2) in the conveyance direction F, the area of contact with the roller surface decreases, and this decreases the heating amount from the upper surface of the carrier tape 20. On the other hand, as the position of the convey path changing roller 41 moves to the downstream side (e.g., P3) in the conveyance direction F, the area of contact with the roller surface increases, and this increases the heating amount from the upper surface of the carrier tape 20.

As described above, the laminating apparatus according to this embodiment can achieve the same functions and effects as in the first embodiment while freely controlling not only the heating amount from the lower surface of the carrier tape 20 but also the heating amount from its upper surface.

### Third Embodiment

The third embodiment of the present invention will be described below.

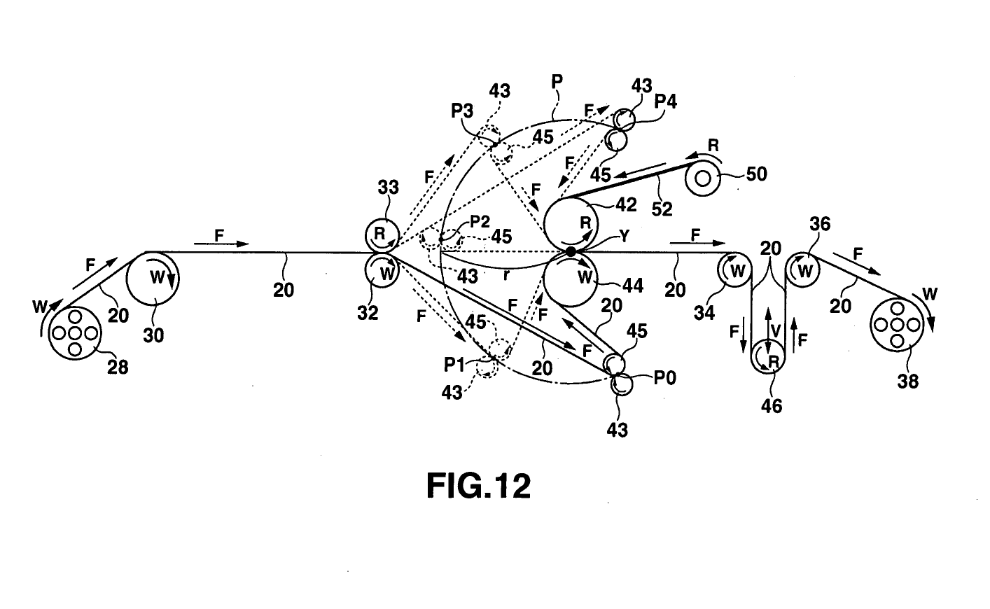

FIG. 12 is a system configuration view showing an example of a laminating apparatus using a laminating method according to the third embodiment.

That is, the laminating apparatus according to this embodiment is a modification of the laminating apparatus according to the second embodiment. The only difference is that a pair of convey path changing rollers 43 and 45 are used instead of the convey path changing roller 41. Therefore, only the difference will be described below, and a repetitive explanation will be avoided. Note that a pressure controller 48 is not shown in FIG. 12.

The pair of convey path changing rollers 43 and 45 oppose each other, and the nearest point (e.g., P0 to P4 in FIG. 12) between them can move along a circumference P of a circle having a point Y as the center and a radius r. The radius r is a distance by which even when the nearest point moves along the circumference P, the convey path changing roller 43 does not collide against conveyor rollers 32 and 33, and the convey path changing roller 45 does not collide against heating/pressing rollers 42 and 44.

When the pair of convey path changing rollers 43 and 45 are on the side of the heating/pressing roller 42 as indicated by P2, P3, or P4, a carrier tape 20 which is conveyed from the conveyor rollers 32 and 33 is wound in a clockwise direction W on the convey path changing roller 43, and relayed to the convey path changing roller 45 at the nearest point (e.g., P2, P3, or P4) of the two rollers. The convey path changing roller 45 rotates in a counterclockwise direction R to introduce the carrier tape 20 between the pair of heating/pressing rollers 42 and 44.

On the other hand, when the pair of convey path changing rollers 43 and 45 are on the side of the heating/pressing roller 44 as indicated by P0 or P1, the carrier tape 20 which is conveyed from the conveyor rollers 32 and 33 is introduced between the convey path changing rollers 43 and 45 and then wound in the counterclockwise direction R on the convey path changing roller 45. Furthermore, the convey path changing roller 45 rotates in the counterclockwise direction R to introduce the carrier tape 20 between the pair of heating/pressing rollers 42 and 44.

With this arrangement, the carrier tape 20 can always be held between the convey path changing rollers 43 and 45. Therefore, unlike in the second embodiment, it is unnecessary to temporarily stop the conveyance of the carrier tape 20, and manually switch the positions of winding of the carrier tape 20 on the convey path changing roller 41. That is, it is possible, without stopping the conveyance of the carrier tape 20, to change the positions of the convey path changing rollers 43 and 45 from the side of the heating/pressing roller 42 as indicated by P2, P3, or P4 shown in FIG. 12 to the side of the heating/pressing roller 44 as indicated by P0 or P1 shown in FIG. 12 or vice versa.

As described above, the laminating apparatus according to this embodiment can achieve the same functions and effects as in the second embodiment without stopping the conveyance of the carrier tape 20.

### Fourth Embodiment

The fourth embodiment of the present invention will be described below.

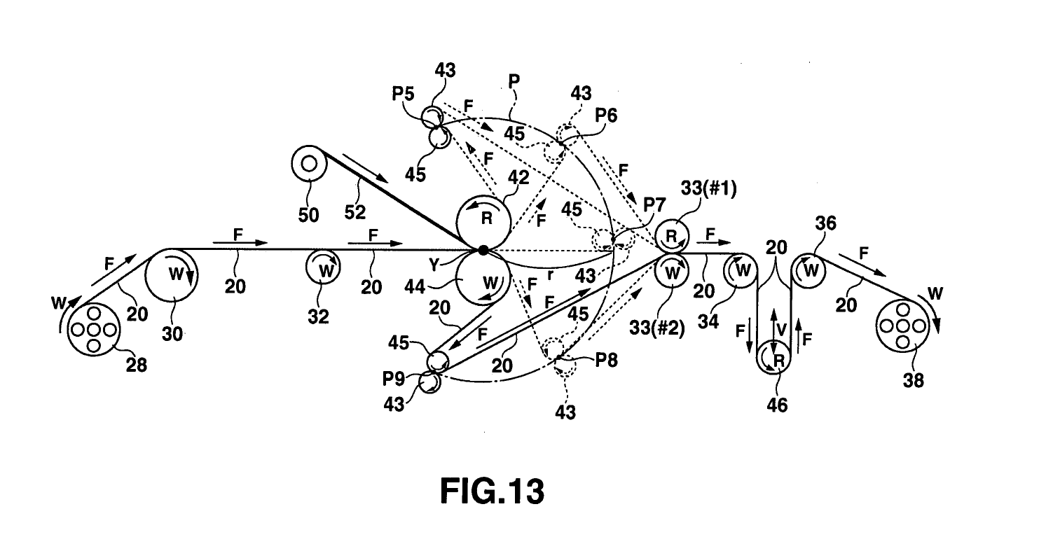

FIG. 13 is a system configuration view showing an example of a laminating apparatus using a laminating method according to the fourth embodiment.

That is, the laminating apparatus according to this embodiment is a modification of the laminating apparatus according to the third embodiment. Therefore, only the difference will be described below, and a repetitive explanation will be avoided. Note that a pressure controller 48 is not shown in FIG. 13.

That is, in the third embodiment, the pair of convey path changing rollers 43 and 45 are arranged upstream of the heating/pressing rollers 42 and 44. In the laminating apparatus according to this embodiment, however, a pair of convey path changing rollers 43 and 45 are arranged downstream of heating/pressing rollers 42 and 44. In accordance with this arrangement, a pair of conveyor rollers 33(#1) and 33(#2) opposing each other are also arranged downstream of the heating/pressing rollers 42 and 44. In addition, a resist supply roller 50 is placed upstream of the heating/pressing rollers 42 and 44 so as not to interfere with the movement of the convey path changing rollers 43 and 45 which are moved downstream of the heating/pressing rollers 42 and 44 along a circumference P having a point Y as the center.

When the convey path changing rollers 43 and 45 are on the side of the heating/pressing roller 42 as indicated by P5, P6, or P7, a carrier tape 20 which is fed from the heating/pressing rollers 42 and 44 is raised in FIG. 13, and wound in a counterclockwise direction R on the convey path changing roller 45. After that, the carrier tape 20 is relayed to the convey path changing roller 43 at the nearest point (e.g., P5, P6, or P7) of the two rollers. The convey path changing roller 43 then rotates in a clockwise direction W to introduce the carrier tape 20 between conveyor rollers 33 and 34.

In this case, as the positions of the convey path changing rollers 43 and 45 move to the upstream side (e.g., P5) in a conveyance direction F, the upper surface of the carrier tape 20 is brought into contact more deeply with the roller surface of the heating/pressing roller 42. This increases the area of contact with the roller surface, and hence increases the heating amount from the upper surface of the carrier tape 20. On the other hand, as the positions of the convey path changing rollers 43 and 45 move to the downstream side (e.g., P7) in the conveyance direction F, the upper surface of the carrier tape 20 is brought into contact more shallowly with the roller surface of the heating/pressing roller 42. This decreases the area of contact with the roller surface, and hence decreases the heating amount from the upper surface of the carrier tape 20.

When the convey path changing rollers 43 and 45 are on the side of the heating/pressing roller 44 as indicated by P8 or P9, the carrier tape 20 which is fed from the heating/pressing rollers 42 and 44 is lowered in FIG. 13, and wound in the counterclockwise direction R on the convey path changing roller 45. The convey path changing roller 45 rotates in the counterclockwise direction R to introduce the carrier tape 20 between the pair of conveyor rollers 33(#1) and 33(#2).

In this case, as the positions of the convey path changing rollers 43 and 45 move to the upstream side (e.g., P9) in the conveyance direction F, the lower surface of the carrier tape 20 is brought into contact more deeply with the roller surface of the heating/pressing roller 44. This increases the area of contact with the roller surface, and hence increases the heating amount from the lower surface of the carrier tape 20. On the other hand, as the positions of the convey path changing rollers 43 and 45 move to the downstream side (e.g., P8) in the conveyance direction F, the lower surface of the carrier tape 20 is brought into contact more shallowly with the roller surface of the heating/pressing roller 44. This decreases the area of contact with the roller surface, and hence decreases the heating amount from the lower surface of the carrier tape 20.

The above arrangement can also achieve the same functions and effects as in the third embodiment. In this embodiment, the convey path changing rollers 43 and 45 described in the third embodiment are arranged downstream of the heating/pressing rollers 42 and 44. However, the same functions and effects can also be achieved by similarly arranging, downstream of the heating/pressing rollers 42 and 44, the convey path changing roller 40 described in the first embodiment and the convey path changing roller 41 described in the second embodiment.

### Fifth Embodiment

The fifth embodiment of the present invention will be described below.

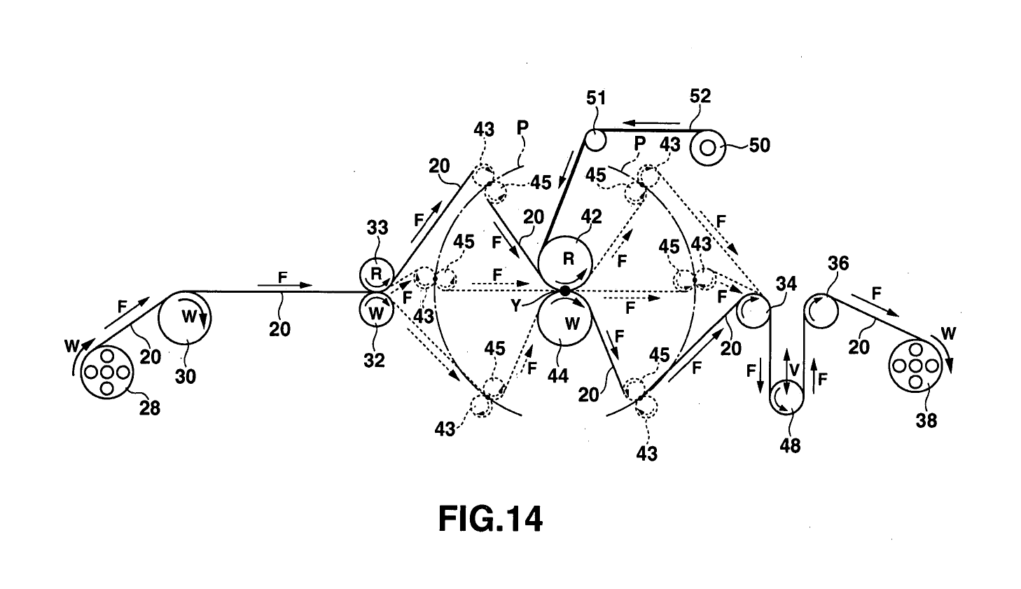

FIG. 14 is a system configuration view showing an example of a laminating apparatus using a laminating method according to the fifth embodiment.

That is, the laminating apparatus according to this embodiment is obtained by combining the laminating apparatuses according to the third and fourth embodiments. Therefore, only the differences will be described below, and a repetitive explanation will be avoided. Note that a pressure controller 48 is not shown in FIG. 14.

That is, in the laminating apparatus according to this embodiment, a pair of convey path changing rollers 43(#1) and 45(#1) are arranged upstream of heating/pressing rollers 42 and 44, and a pair of convey path changing rollers 43(#2) and 45(#2) are arranged downstream of the heating/pressing rollers 42 and 44. Also, a resist supply roller 50 is placed so as not to interfere with the movement of the convey path changing rollers 43 and 45 which move along a circumference P. In addition, a conveyor roller 51 introduces a resist 52, which is unwound from the resist supply roller 50, between the heating/pressing rollers 42 and 44 so as not to interfere with the movement of the convey path changing rollers 43 and 45 which move along the circumference P.

With this arrangement, the heating amount given from the upper surface side of a carrier tape 20 or the heating amount given from its lower surface side can be controlled on both the upstream and downstream sides of the heating/pressing rollers 42 and 44. Accordingly, the heating amount control range can be made twice as large as that when the heating amount is controlled only on either the upstream or downstream side of the heating/pressing rollers 42 and 44 as explained in the first to fourth embodiments.

### Sixth Embodiment

The sixth embodiment of the present invention will be described below.

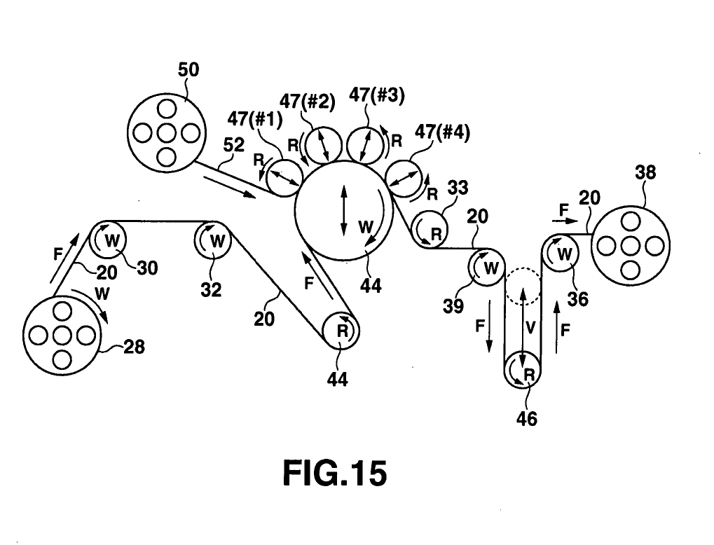

FIG. 15 is a system configuration view showing an example of a laminating apparatus using a laminating method according to the sixth embodiment.

The laminating apparatus according to this embodiment is a modification of the laminating apparatuses according to the first to fifth embodiments. Therefore, only the differences will be described below, and a repetitive explanation will be avoided.

That is, the laminating apparatus according to this embodiment includes, instead of the heating/pressing roller 42, a plurality of heating/pressing rollers 47(#1) to 47(#4) having a diameter smaller than that of the heating/pressing roller 42. Similar to the heating/pressing roller 42, the pressure which is applied from the heating/pressing rollers 47(#1) to 47(#4) to a carrier tape 20 is controlled by a pressure controller 48. However, the pressure controller 48 is not shown in FIG. 15.

The heating/pressing rollers 47(#1) to 47(#4) can independently apply heat and pressure to the carrier tape 20 or, in some cases, to a carrier tape 20 having a surface covered with a resist 52.

With this arrangement, the heating time can be made longer than the pressing time by allowing a certain heating/pressing roller 47 to perform heating but no pressing. On the other hand, the pressing time can be made longer than the heating time by allowing a certain heating/pressing roller 47 to perform pressing but no heating.

By thus adjusting the heating amount and pressing amount for each of the heating/pressing rollers 47(#1) to 47(#4), it is possible to realize fine conditions by combining various heating amounts and pressing amounts.

### Seventh Embodiment

The seventh embodiment of the present invention will be described below.

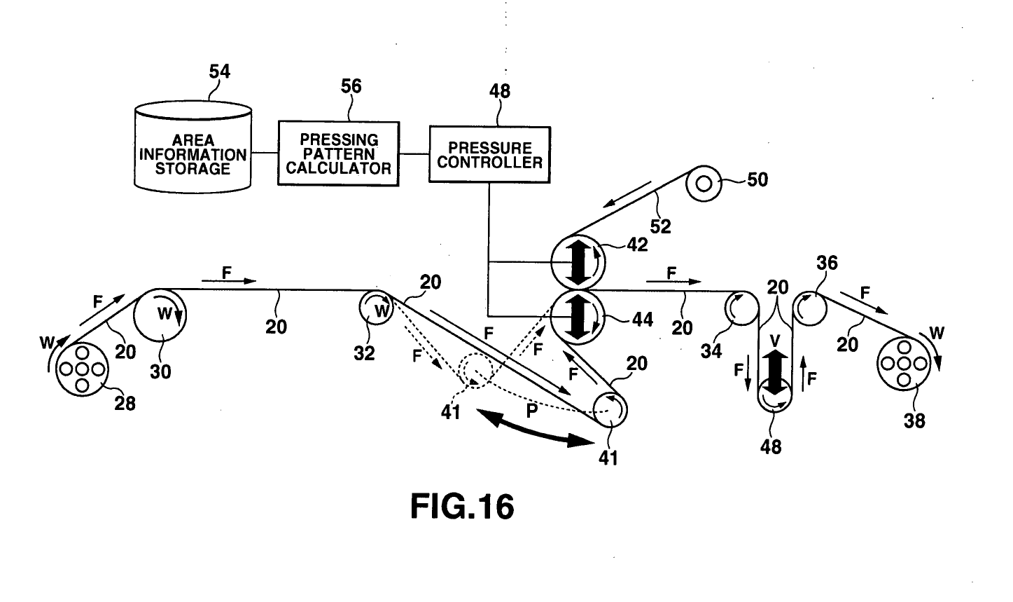

FIG. 16 is a system configuration view showing an example of a laminating apparatus using a laminating method according to the seventh embodiment.

The laminating apparatus according to this embodiment is obtained by adding an area information storage 54 and pressing pattern calculator 56 to the laminating apparatuses according to the first to sixth embodiments. FIG. 16 representatively shows an arrangement obtained by adding the area information storage 54 and pressing pattern calculator 56 to the laminating apparatus having the arrangement shown in FIG. 8. Therefore, only the differences from the first to sixth embodiments will be described below, and a repetitive explanation will be avoided.

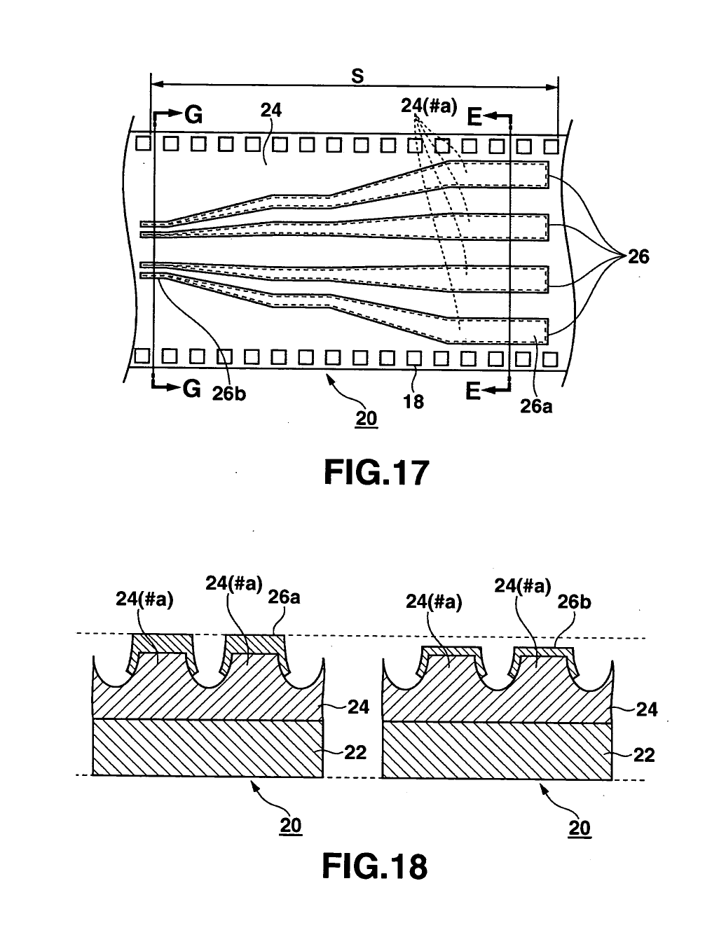

As shown in FIG. 9, on the surface of a carrier tape 20 of this embodiment, resists 26 are arranged in portions corresponding to predetermined wiring patterns. FIG. 17 is a plan view showing an example of the carrier tape 20 on which the resists 26 are arranged. That is, as shown in FIG. 17, the resists 26 are not evenly arranged on the surface of the carrier tape 20, but they are generally nonuniformly arranged.

When the carrier tape 20 on which the resists 26 are thus nonuniformly arranged is heated under an even pressure by heating/pressing rollers 42 and 44, the pressure which each resist 26 receives in a portion where the density of the resists 26 is high differs from the pressure which each resist 26 receives in a portion where the density of the resists 26 is low. For example, the density of resists 26a arranged in a plane extending along a line E-E in FIG. 17 is higher than the density of resists 26b arranged in a plane extending along a line G-G in FIG. 17. If these planes extending along the lines E-E and G-G are heated under the same pressure by the heating/pressing rollers 42 and 44, the pressure applied to each resist 26a in the plane extending along the line E-E is small, whereas the pressure applied to each resist 26b in the plane extending along the line G-G is large. Therefore, as shown on the left- and right-side views of FIG. 18, which are vertical sectional views taken along the lines E-E and G-G, respectively, the resists 26b arranged in the plane extending along the line G-G are depressed more than the resists 26a arranged in the plane extending along the line E-E.

In the laminating apparatus according to this embodiment, therefore, the heating/pressing rollers 42 and 44 apply a predetermined pressure to each resist 26 in the longitudinal direction of the carrier tape 20, regardless of the arrangement density of the resists 26. For this purpose, as shown in FIG. 16, the laminating apparatus according to this embodiment includes the area information storage 54 and pressing pattern calculator 56.

The area information storage 54 prestores arrangement information and area information of stacked materials, such as the resists 26, stacked on the carrier tape 20.

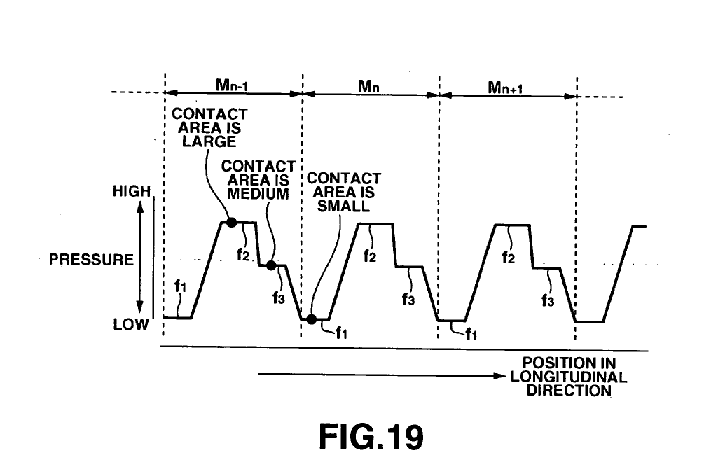

On the basis of these pieces of information stored in the area information storage 54, the pressing pattern calculator 56 calculates a pressing pattern with which a predetermined pressure is applied to each stacked material by the heating/pressing rollers 42 and 44 in the longitudinal direction of the carrier tape 20, and outputs the calculation result to the pressure controller 48. FIG. 19 is a graph showing an example of this pressing pattern. Referring to FIG. 19, the abscissa indicates the position in the longitudinal direction of the carrier tape 20, and the ordinate indicates the pressure the heating/pressing rollers 42 and 44 apply to the carrier tape 20.

As shown in FIG. 17, resist arrangements S having the same pattern are generally repeated on the carrier tape 20. Referring to FIG. 19, Mₙ₋₁ indicates the pressing pattern of an (n−1)th resist arrangement Sₙ₋₁; Mₙ, the pressing pattern of an nth resist arrangement Sₙ; and Mₙ₊₁, the pressing pattern of an (n+1)th resist arrangement Sₙ₊₁. Since the resist arrangements S ( . . . , Sₙ₋₁, Sₙ, Sₙ₊₁, . . . ) are identical, the identical patterns M ( . . . , Mₙ₋₁, Mₙ, Mₙ₊₁, . . . ) are repeated. Assume that in the resist arrangement Sn corresponding to the pressing pattern Mn as shown in FIG. 19, no resists 26 are arranged in the start portion (to be conveyed first), the largest number of resists 26 are arranged in the intermediate portion conveyed subsequently to the start portion, and resists 26 are arranged at a density about half that in the intermediate portion in the end portion conveyed subsequently to the intermediate portion. As shown in FIG. 19, in the pressing pattern M corresponding to the resist arrangement S, a pressure f₁ in the start portion is the lowest, a pressure f₂ in the intermediate portion is the highest, and a pressure f₃ in the end portion is about half the pressure f₂.

The pressure controller 48 outputs a control instruction matching the pressing pattern as shown in FIG. 19 to the heating/pressing rollers 42 and 44. Therefore, the resists 26 arranged on the carrier tape 20 are heated by the heating/pressing rollers 42 and 44 as they are pressed in accordance with this pressing pattern.

The function of the laminating apparatus according to this embodiment having the above arrangement will be described below.

That is, the area information storage 54 prestores arrangement information and area information of stacked materials, such as the resists 26, stacked on the carrier tape 20.

On the basis of these pieces of information stored in the area information storage 54, the pressing pattern calculator 56 calculates a pressing pattern with which each resist 26 stacked on the carrier tape 20 is pressed by a predetermined pressure by the heating/pressing rollers 42 and 44 in the longitudinal direction of the carrier tape 20, and outputs the calculated pressing pattern to the pressure controller 48.

The pressure controller 48 outputs a control instruction based on the calculated pressing pattern to the heating/pressing rollers 42 and 44.

The carrier tape 20 introduced between the heating/pressing rollers 42 and 44 is heated as it is pressed in accordance with this pressing pattern. Accordingly, the resists 26 arranged on the carrier tape 20 are heated as they are pressed by the predetermined pressure in the longitudinal direction by the heating/pressing rollers 42 and 44. As a consequence, the push amounts of the resists 26 can be made substantially equal to each other without producing the nonuniform push amounts as illustrated in the left- and right-side views of FIG. 18.

The best mode for carrying out the present invention has been explained above with reference to the accompanying drawing. However, the present invention is not limited to this arrangement. Those skilled in the art can anticipate various changes and modifications within the scope of claims and the range of the invented technical ideas. It is to be understood that these changes and modifications are also incorporated in the technical scope of the present invention.

For example, the first to fifth embodiments and seventh embodiment are described by taking the pair of heating/pressing rollers 42 and 44 as an example. However, the heating/pressing rollers 42 and 44 need not make a pair but can have different diameters. In this case, a portion of the outer circumference of a small-diameter heating/pressing roller is positioned, on the circumference of a large-diameter heating/pressing roller, between first and second contact points at which the carrier tape 20 comes into contact with the large-diameter heating/pressing roller. In this way, the same effects as when the pair of heating/pressing rollers 42 and 44 are used can be achieved. Also, a plurality of small-diameter heating/pressing rollers may be used as shown in FIG. 15.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

1. A laminating method comprising:
a conveyance step of conveying a tape-like material to be heated and pressed in a longitudinal direction by conveyor means;
a heating/pressing step of heating and pressing the material conveyed by the conveyor means on a roller surface of a heating/pressing roller; and
a contact area adjusting step of adjusting a contact area in which the material comes into contact with the roller surface.

2. A method according to claim 1, wherein in the contact area adjusting step, the contact area is adjusted by changing a part of at least one of a convey path before heating and pressing along which the material is conveyed to the heating/pressing roller, and a convey path after heating and pressing along which the material heated and pressed by the heating/pressing roller is conveyed.

3. A laminating method comprising:
a conveyance step of conveying a tape-like material to be heated and pressed in a longitudinal direction by conveyor means;
a heating/pressing step of heating and pressing the material conveyed by the conveyor means on a roller surface of a heating/pressing roller;
a contact area adjusting step of adjusting a contact area in which the material comes into contact with the roller surface; and
a time changing step of making a heating time during which the material is heated by the heating/pressing roller different from a pressing time during which the material is pressed by the heating/pressing roller.

4. A laminating method comprising:
a conveyance step of conveying a tape-like material to be heated and pressed in a longitudinal direction by conveyor means;
a heating/pressing step of heating and pressing the material conveyed by the conveyor means on a roller surface of each of a plurality of heating/pressing rollers; and
a time changing step of making a heating time during which the material is heated by each heating/pressing roller different from a pressing time during which the material is pressed by each heating/pressing roller.

5. A laminating method comprising:
a conveyance step of conveying a tape-like material to be heated and pressed in a longitudinal direction by conveyor means; and
a contact area adjusting step of changing a part of a convey path of the material conveyed by the conveyor means such that the material is introduced, via the changed convey path, between a pair of roller surfaces of a pair of heating/pressing rollers which are so arranged that the roller surfaces oppose each other, and which heat the material introduced between the pair of roller surfaces from upper and lower surfaces of the material by the roller surfaces, thereby adjusting contact areas in which the upper and lower surfaces of the material come into contact with the roller surfaces.

6. A laminating method comprising:
a conveyance step of conveying a tape-like material to be heated and pressed in a longitudinal direction by conveyor means; and
a contact area adjusting step of changing a part of a convey path of the material conveyed by the conveyor means, and conveyed from between a pair of roller surfaces of a pair of heating/pressing rollers which are so arranged that the roller surfaces oppose each other, and which heat and press the material introduced between the pair of roller surfaces from upper and lower surfaces of the material by the roller surfaces, thereby adjusting contact areas in which the upper and lower surfaces of the material come into contact with the roller surfaces.

7. A laminating method comprising:
a conveyance step of conveying a tape-like material to be heated and pressed in a longitudinal direction by conveyor means;
a first contact area adjusting step of changing a part of a convey path of the material conveyed by the conveyor means such that the material is introduced, via the changed convey path, between a pair of roller surfaces of a pair of heating/pressing rollers which are so arranged that the roller surfaces oppose each other, and which heat the material introduced between the pair of roller surfaces from upper and lower surfaces of the material by the roller surfaces, thereby adjusting contact areas in which the upper and lower surfaces of the material come into contact with the roller surfaces; and
a second contact area adjusting step of changing a part of a convey path of the material conveyed by the conveyor means and discharged from between the pair of roller surfaces, thereby adjusting contact areas in which the upper and lower surfaces of the material come into contact with the roller surfaces.

8. A method according to any one of claims 1 to 7, further comprising:
a stacked material information storage step of prestoring, in a stacked material information storage database, arrangement information and area information of stacked materials stacked on the material to be heated and pressed;
a pressing pattern calculation step of calculating, on the basis of the information stored in the stacked material information storage database, a pressing pattern by which a predetermined pressure is applied to the stacked materials by the heating/pressing roller in the longitudinal direction of the material to be heated and pressed; and
a pressing step of causing the heating/pressing roller to apply a pressure to the material to be heated and pressed, in accordance with the pressing pattern calculated in the pressing pattern calculation step, thereby heating the stacked materials as they are pressed by the predetermined pressure in the longitudinal direction by the heating/pressing roller.

9. A laminating apparatus comprising:
conveyor means for conveying a tape-like material to be heated and pressed in a longitudinal direction;
a heating/pressing roller which heats and presses the material conveyed by the conveyor means on a roller surface; and
contact area adjusting means for adjusting a contact area in which the material comes into contact with the roller surface.

10. An apparatus according to claim 9, wherein the contact area adjusting means adjusts the contact area by changing a part of at least one of a convey path before heating and pressing along which the material is conveyed to the heating/pressing roller, and a convey path after heating and pressing along which the material heated and pressed by the heating/pressing roller is conveyed.

11. A laminating apparatus comprising:
conveyor means for conveying a tape-like material to be heated and pressed in a longitudinal direction;
a pair of heating/pressing rollers which are so arranged that a pair of roller surfaces thereof oppose each other, and which heat and press the material introduced between the pair of roller surfaces from upper and lower surfaces of the material by the roller surfaces; and
contact area adjusting means for changing a part of a convey path of the material conveyed by the conveyor means such that the material is introduced between the pair or roller surfaces via the changed convey path, thereby adjusting contact areas in which the upper and lower surfaces of the material come into contact with the roller surfaces.

12. A laminating apparatus comprising:
conveyor means for conveying a tape-like material to be heated and pressed in a longitudinal direction;
a pair of heating/pressing rollers which are so arranged that a pair of roller surfaces thereof oppose each other, and which heat and press the material introduced between the pair of roller surfaces from upper and lower surfaces of the material by the roller surfaces; and
contact area adjusting means for changing a part of a convey path of the material conveyed by the conveyor means and conveyed from between the pair of roller surfaces, thereby adjusting contact areas in which the upper and lower surfaces of the material come into contact with the roller surfaces.

13. A laminating apparatus comprising:
conveyor means for conveying a tape-like material to be heated and pressed in a longitudinal direction;
a pair of heating/pressing rollers which are so arranged that a pair of roller surfaces thereof oppose each other, and which heat and press the material introduced between the pair of roller surfaces from upper and lower surfaces of the material by the roller surfaces;
first contact area adjusting means for changing a part of a convey path of the material conveyed by the conveyor means such that the material is introduced between the pair of opposing roller surfaces via the changed convey path, thereby adjusting contact areas in which the upper and lower surfaces of the material come into contact with the roller surfaces; and
second contact area adjusting means for changing a part of a convey path of the material conveyed by the conveyor means and discharged from between the pair of roller surfaces, thereby adjusting contact areas in which the upper and lower surfaces of the material come into contact with the roller surfaces.

14. An apparatus according to any one of claims 11 to 13, wherein two heating/pressing rollers opposing each other and different in diameter are used instead of the pair of heating/pressing rollers.

15. An apparatus according to claim 14, wherein a portion of an outer circumference of a small-diameter heating/pressing roller is positioned, on a circumference of a large-diameter heating/pressing roller, between first and second contact points at which the material comes into contact with the large-diameter heating/pressing roller.

16. An apparatus according to claim 15, wherein at least two heating/pressing rollers different in diameter are used instead of the pair of heating/pressing rollers, and a part of an outer circumference of at least one heating/pressing roller having a diameter smaller than that of a large-diameter heating/pressing roller is positioned, on a circumference of the large-diameter heating/pressing roller, between first and second contact points at which the material comes into contact with the large-diameter heating/pressing roller.

17. An apparatus according to claim 16, further comprising:
stacked material information storage means for prestoring arrangement information and area information of stacked materials stacked on the material to be heated and pressed;
pressing pattern calculating means for calculating, on the basis of the information stored in the stacked material information storage, a pressing pattern by which a predetermined pressure is applied to the stacked materials by the heating/pressing roller in the longitudinal direction of the material to be heated and pressed; and
pressing means for causing the heating/pressing roller to apply a pressure to the material to be heated and pressed, in accordance with the pressing pattern calculated by the pressing pattern calculating means, thereby heating the stacked materials as the stacked materials are pressed by the predetermined pressure in the longitudinal direction by the heating/pressing roller.

18. An apparatus according to any one of claims 11 to 13, wherein at least two heating/pressing rollers different in diameter are used instead of the pair of heating/pressing rollers, and a part of an outer circumference of at least one heating/pressing roller having a diameter smaller than that of a large-diameter heating/pressing roller is positioned, on a circumference of the large-diameter heating/pressing roller, between first and second contact points at which the material comes into contact with the large-diameter heating/pressing roller.

19. An apparatus according to claim 18, further comprising:
stacked material information storage means for prestoring arrangement information and area information of stacked materials stacked on the material to be heated and pressed;
pressing pattern calculating means for calculating, on the basis of the information stored in the stacked material information storage, a pressing pattern by which a predetermined pressure is applied to the stacked materials by the heating/pressing roller in the longitudinal direction of the material to be heated and pressed; and
pressing means for causing the heating/pressing roller to apply a pressure to the material to be heated and pressed, in accordance with the pressing pattern calculated by the pressing pattern calculating means, thereby heating the stacked materials as the stacked materials are pressed by the predetermined pressure in the longitudinal direction by the heating/pressing roller.

20. An apparatus according to claim 14, wherein at least two heating/pressing rollers different in diameter are used instead of the pair of heating/pressing rollers, and a part of an outer circumference of at least one heating/pressing roller having a diameter smaller than that of a large-diameter heating/pressing roller is positioned, on a circumference of the large-diameter heating/pressing roller, between first and second contact points at which the material comes into contact with the large-diameter heating/pressing roller.

21. An apparatus according to claim 20, further comprising:
stacked material information storage means for prestoring arrangement information and area information of stacked materials stacked on the material to be heated and pressed;
pressing pattern calculating means for calculating, on the basis of the information stored in the stacked material information storage, a pressing pattern by which a predetermined pressure is applied to the stacked materials by the heating/pressing roller in the longitudinal direction of the material to be heated and pressed; and
pressing means for causing the heating/pressing roller to apply a pressure to the material to be heated and pressed, in accordance with the pressing pattern calculated by the pressing pattern calculating means, thereby heating the stacked materials as the stacked materials are pressed by the predetermined pressure in the longitudinal direction by the heating/pressing roller.

22. An apparatus according to any one of claims 9 to 13, further comprising:
stacked material information storage means for prestoring arrangement information and area information of stacked materials stacked on the material to be heated and pressed;
pressing pattern calculating means for calculating, on the basis of the information stored in the stacked material information storage, a pressing pattern by which a predetermined pressure is applied to the stacked materials by the heating/pressing roller in the longitudinal direction of the material to be heated and pressed; and
pressing means for causing the heating/pressing roller to apply a pressure to the material to be heated and pressed, in accordance with the pressing pattern calculated by the pressing pattern calculating means, thereby heating the stacked materials as the stacked materials are pressed by the predetermined pressure in the longitudinal direction by the heating/pressing roller.

23. An apparatus according to claim 14, further comprising:
stacked material information storage means for prestoring arrangement information and area information of stacked materials stacked on the material to be heated and pressed;
pressing pattern calculating means for calculating, on the basis of the information stored in the stacked material information storage, a pressing pattern by which a predetermined pressure is applied to the stacked materials by the heating/pressing roller in the longitudinal direction of the material to be heated and pressed; and
pressing means for causing the heating/pressing roller to apply a pressure to the material to be heated and pressed, in accordance with the pressing pattern calculated by the pressing pattern calculating means, thereby heating the stacked materials as the stacked materials are pressed by the predetermined pressure in the longitudinal direction by the heating/pressing roller.

24. An apparatus according to claim 15, further comprising:
stacked material information storage means for prestoring arrangement information and area information of stacked materials stacked on the material to be heated and pressed;
pressing pattern calculating means for calculating, on the basis of the information stored in the stacked material information storage, a pressing pattern by which a predetermined pressure is applied to the stacked materials by the heating/pressing roller in the longitudinal direction of the material to be heated and pressed; and
pressing means for causing the heating/pressing roller to apply a pressure to the material to be heated and pressed, in accordance with the pressing pattern calculated by the pressing pattern calculating means, thereby heating the stacked materials as the stacked materials are pressed by the predetermined pressure in the longitudinal direction by the heating/pressing roller.

25. A laminating apparatus comprising:
conveyor means for conveying a tape-like material to be heated and pressed in a longitudinal direction;
a heating/pressing roller which heats and presses the material conveyed by the conveyor means on a roller surface;
contact-area adjusting means for adjusting a contact area in which the material comes into contact with the roller surface; and
time changing means for making a heating time during which the material is heated by the heating/pressing roller different from a pressing time during which the material is pressed by the heating/pressing roller.
